(19) United States
(12) Patent Application Publication
(10) Pub. No.: US 2023/0411716 A1
(43) Pub. Date: Dec. 21, 2023

(54) BATTERY PACK

(71) Applicant: Samsung SDI Co., Ltd., Yongin-si (KR)

(72) Inventor: Hyeok Lee, Yongin-si (KR)

(21) Appl. No.: 18/212,091

(22) Filed: Jun. 20, 2023

(30) Foreign Application Priority Data
Jun. 21, 2022 (KR) 10-2022-0075678

(51) Int. Cl. H01M 10/48; H01M 50/209; H01M 50/507

(52) U.S. Cl. CPC H01M 10/482; H01M 50/209; H01M 50/507

(57) ABSTRACT

A battery pack includes: a plurality of battery cells; and a sensing substrate configured to collect state information from the plurality of battery cells. The sensing substrate includes: a main body; branch portions connected to the main body and spaced apart from the sensing substrate such that first deformation accommodating spaces are formed between the main body and the branch portions; and ring units connected to the branch portions and forming second deformation accommodating spaces.

### CROSS-REFERENCE TO RELATED APPLICATION

This application claims priority to and the benefit of Korean Patent Application No. 10-2022-0075678, filed on Jun. 21, 2022, in the Korean Intellectual Property Office, the entire disclosure of which is incorporated herein by reference.

### BACKGROUND

### 1. Field

Aspects of embodiments of the present disclosure relate to a battery pack.

### 2. Description of the Related Art

Secondary batteries are designed to be charged and discharged, unlike primary batteries, which are not designed to be charged. Secondary batteries may be used as energy sources for mobile devices, electric vehicles, hybrid vehicles, electric bicycles, uninterruptible power supplies, etc., and may be used in the form of a single battery or in the form of a module in which multiple batteries are connected to each other and bundled into a single unit depending on the type of external devices applied thereto.

While small mobile devices, such as cell phones, can operate for a certain period of time with the output and capacity of a single battery, a battery in the form of a module including a plurality of batteries may be used for a device requiring long-term driving and high power driving as in, for example, electric cars and hybrid cars with high power consumption. Further, the output voltage or output current may be increased depending on the number of batteries included in the module.

### SUMMARY

Embodiments of the present disclosure provide a battery pack including a sensing substrate having deformation accommodating spaces such that a part of the sensing substrate, which is for acquiring state information of battery cells, may be flexibly deformed to accommodate positional movement of bus bars due to volume expansion, such as swelling, of the battery cells caused during charging and discharging of the battery cells to prevent or reduce the accumulation of internal stress and the resulting damage.

Additional aspects and features of the present disclosure will be set forth, in part, in the description that follows and, in part, will be apparent from the description or may be learned by practice of the described embodiments of the present disclosure.

According to an embodiment of the present disclosure, a battery pack includes: a plurality of battery cells; and a sensing substrate configured to collect state information from the plurality of battery cells. The sensing substrate includes: a main body; branch portions connected to the main body and spaced apart from the sensing substrate such that first deformation accommodating spaces are formed between the main body and the branch portions; and ring units connected to the branch portions and forming second deformation accommodating spaces.

The branch portions and the main body may surround the first deformation accommodating spaces in a plan view, and the ring units may entirely surround the second deformation accommodating spaces in the plan view.

The first and second deformation accommodating spaces may be closed spaces.

The first deformation accommodating spaces may extend in a first direction between the branch portions, and the main body of the sensing substrate may extend in the first direction.

The first deformation accommodating space may be closed by first support units connected to the main body at both ends in the first direction.

The first support units may have a rounded shape at where they connect the branch portions and the main body to each other.

Each of the ring units may have a circular closed loop shape and may surround each of the second deformation accommodating spaces in a plan view.

The ring units may be connected to the main body and the branch portions extending to both sides of each of the ring units by three second support units extending from a periphery of the ring unit.

One second support unit from among the second support units connecting the ring unit and the main body may divide the first deformation accommodating space formed between the branch portions and the main body of the sensing substrate into two deformation accommodating spaces.

Connection positions connected to the battery cells may be formed on the branch portions.

The connection positions may include first and second connection positions at both sides of each of the ring units with the ring units as the center.

The first and second connection positions may be arranged in a first direction in which the plurality of battery cells are arranged.

The first and second connection positions may be connected to first and second bus bars adjacent to each other in a first direction.

Each of the first and second bus bars may connect different battery cells to each other.

A first support unit at one end closing the first deformation accommodating space may be formed on the opposite side of the ring unit with the first connection position as the center, and another first support unit at another end closing the first deformation accommodating space may be formed on the opposite side of the ring unit with the second connection position as the center.

With the center ring as the center, the first and second connection positions may be formed adjacent to the ring unit, and the first support unit at one end and the first support unit at another end may be formed relatively distant from the ring unit.

The first and second connection positions may be connected to first and second connection units located adjacent to each other in the first direction for connection with the first and second bus bars.

The first and second connection positions may be connected to the first and second connection units connected to the first and second bus bars.

The ring units may be connected to the main body and the branch portions extending to both sides of each of the ring units by three second support units extending from a periphery of the ring unit, and the ring unit may be connected, by the second support units formed on both sides of the ring unit, to the branch portion where the first connection position is formed and to the branch portion where the second connection position is formed.

### BRIEF DESCRIPTION OF THE DRAWINGS

The above and other aspects and features of the present disclosure will be more apparent from the following description, taken in conjunction with the accompanying drawings, in which:

FIG. 1 is an exploded perspective view of a battery pack according to an embodiment;

FIG. 2 is an exploded perspective view of a portion of the battery pack shown in FIG. 1;

FIG. 3 is a plan view showing a sensing structure for collecting state information of battery cells as a part of the battery pack shown in FIG. 1; and

FIG. 4 is a plan view showing first and second pin members fitted into first and second deformation accommodating spaces for temporarily fixing the sensing substrate as a part of the battery pack shown in FIG. 3.

### DETAILED DESCRIPTION

Reference will now be made in detail to embodiments, examples of which are illustrated in the accompanying drawings. In this regard, the described embodiments may have different forms and should not be construed as being limited to the descriptions set forth herein. Accordingly, embodiments are merely described below, by referring to the figures, to explain aspects and features of the present description.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Hereinafter, a battery pack according to an embodiment of the present disclosure will be described with reference to the accompanying drawings.

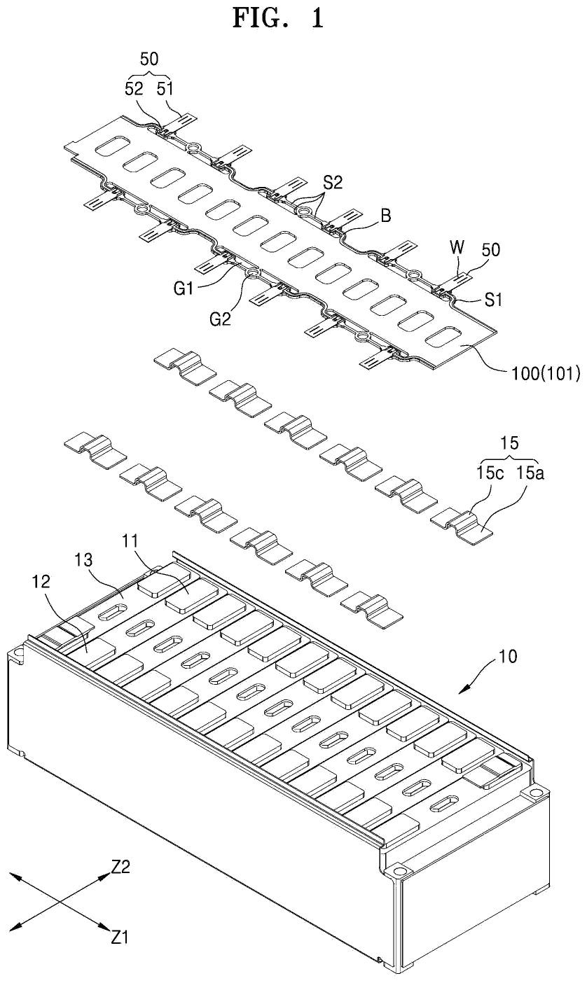

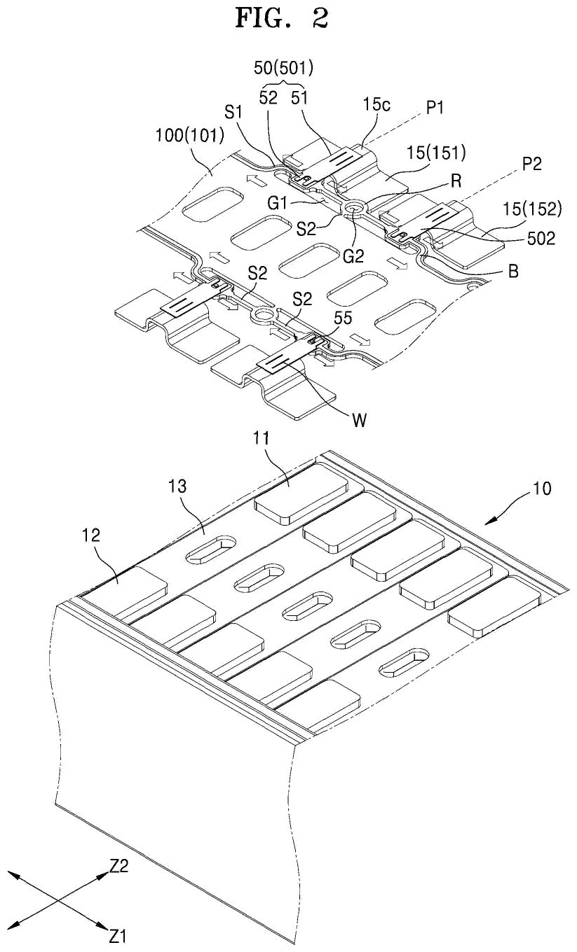

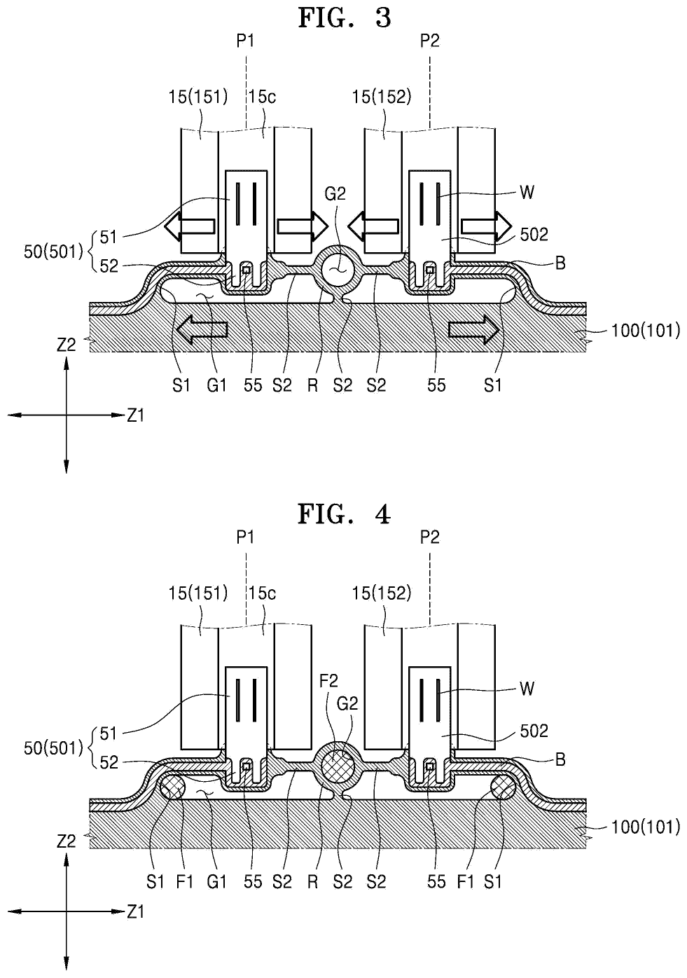

FIG. 1 is an exploded perspective view of a battery pack according to an embodiment, FIG. 2 is an exploded perspective view of a portion of the battery pack shown in FIG. 1, FIG. 3 is a plan view showing a sensing structure including a sensing substrate and connection units connected to the sensing substrate as a part of the battery pack shown in FIG. 1, and FIG. 4 is a plan view showing first and second pin members inserted into first and second deformation accommodating spaces for temporarily fixing the sensing substrate as a part of the battery pack shown in FIG. 3.

Referring to FIGS. 1 to 4, a battery pack, according to an embodiment of the present disclosure, may include a plurality of battery cells 10 and a sensing substrate 100 for collecting (or configured to collect) state information from the plurality of battery cells 10. The sensing substrate 100 may include a main body 101, branch portions B connected to (e.g., extending from) the main body 101 by bypassing (e.g., by extending to be spaced apart from an edge of the main body 101) such that first deformation accommodating spaces G1 are provided (or positioned) between the main body 101 and the branch portions B, and ring units R connected to the branch portions B and forming second deformation accommodating spaces G2.

In an embodiment, the sensing substrate 100 may extend across terminal surfaces 13 of the plurality of battery cells 10 arranged in a first direction Z1, and first and second electrode terminals 11 and 12, having different polarities, may be formed on the terminal surfaces 13 of each of the battery cells 10 in a second direction Z2 crossing the first direction Z1. The first and second electrode terminals 11 and 12 may form first and second rows of electrode terminals 11 and 12 on both sides (e.g., opposite sides) of the battery cells 10 in the second direction Z2 along the plurality of battery cells 10 arranged in the first direction Z1. Bus bars 15, electrically connecting the battery cells 10 by connecting the first and second electrode terminals 11 and 12 of the battery cells 10, may form first and second rows of bus bars 15 on both sides (e.g., opposite sides) of the battery cells 10 in the second direction Z2 along the battery cells arranged in the first direction Z1 for electrical connection with the first and second rows of electrode terminals 11 and 12.

Referring to FIG. 1, in an embodiment, the bus bar 15 may include connection pieces (e.g., connection portions) 15a formed at both ends (e.g., opposite ends) of the bus bar 15 and connected to the electrode terminals 11 and 12 of different battery cells 10 and a link piece (e.g., a link portion) 15c formed at the center of the bus bar 15 to connect (e.g., extending between) the connection pieces 15a at both sides thereof and connected to the electrode terminals 11 and 12 of the different battery cells 10. The link piece 15c may be bent from the connection pieces 15a formed at both ends of the bus bar 15 to elastically deformably connect the connection pieces 15a formed at both ends of the bus bar 15. As described below, in an embodiment, a first connection region 51 of a connection unit 50 may be connected to the link piece 15c of the bus bar 15.

According to an embodiment, the main body 101 of the sensing substrate 100 may refer to a main part of (e.g., may account for most of the area of) the sensing substrate 100 from among components of the sensing substrate 100 except for the branch portions B branched outwardly from the main body 101 of the sensing substrate 100. The branch portion B extend from the main body 101 of the sensing substrate 100 toward the first and second rows of bus bars 15, and the deformation accommodating spaces G1 are positioned between the main body 101 and the branch portions B. For example, in an embodiment, the sensing substrate 100 may include the main body 101 extending at a relatively inner position (e.g., a center position) in the second direction Z2 across (or between) the terminal surfaces 13 of the plurality of battery cells 10 arranged in the first direction Z1 and the branch portions B located at a relatively outer position in the second direction Z2 with the first deformation accommodating space G1 positioned between the main body 101 and the branch portions B with the branch portions B extending from the main body 101 of the sensing substrate 100 toward the first and second rows of bus bars 15. The branch portions B may be positioned at a relatively outer position, spaced apart from the main body 101 of the sensing substrate 100, with the first deformation accommodating space G1 between the main body 101 and the branch portions B. Throughout this description, the inner position may refer to a direction in which the first and second electrode terminals 11 and 12 having different polarities positioned in the second direction Z2 face each other or a relative position along the direction in which the first and second electrode terminals 11 and 12 of different polarities positioned in the second direction Z2 face each other, and the outer position may refer to a direction in which the first and second electrode terminals 11 and 12 of different polarities positioned in the second direction Z2 face away from each other or a relative position along the direction in which the first and second electrode terminals 11 and 12 of different polarities positioned in the second direction Z2 face away from each other.

In an embodiment, the state information of the battery cells 10 may include temperature, voltage, and current of the battery cells 10, and the state information collected from the battery cells 10 may be transferred through the sensing substrate 100 to a battery management unit connected to an end of the sensing substrate 100. In an embodiment, the state information of the battery cells 10 may be obtained through connection units 50 connected to the bus bars 15, which form a thermal and electrical connection with the first and second electrode terminals 11 and 12 of the battery cells 10. For example, temperature information of the battery cells 10 may be obtained through the bus bars 15, which are thermally connected to the first and second electrode terminals 11 and 12 of the battery cells 10, and voltage information of the battery cells 10 may be obtained through the bus bars 15, which are electrically connected to the first and second electrode terminals 11 and 12 of the battery cells 10. In an embodiment, electrical signals related to the state information of the battery cells 10 including temperature information and/or voltage information of the battery cells 10 may be generated through the connection units 50 connected to the bus bars 15, and the generated electrical signals may be transferred to the sensing substrate 100. In an embodiment, the sensing substrate 100 may be connected to the bus bars 15 connected onto the terminal surfaces 13 of the battery cells 10 to collect state information of the battery cells 10. In some embodiments, the sensing substrate 100 may be directly connected onto the terminal surfaces 13 of the battery cells. For example, in some embodiments, that the sensing substrate 100 is connected to the battery cells 10 to collect state information of the battery cells may inclusively mean that the sensing substrate 100 is directly connected to the battery cells 10 (e.g., the terminal surfaces 13 of the battery cells 10) or the sensing substrate 100 is connected to the bus bars 15, which are connected to the battery cells 10.

In an embodiment, the sensing substrate 100 may include the main body 101 and the branch portions B connected to the battery cells 10 (e.g., connected to the bus bars 15), respectively, and extending from the main body 101. The sensing substrate 100 including the main body 101 and the branch portions B may be positioned between the first and second rows of bus bars 15 in whole (e.g., overall); for example, the sensing substrate 100 may be positioned at an inner position between the first and second rows of bus bars 15 in the second direction Z2 crossing the first direction Z1.

In an embodiment, the connection units 50 mediating the connection between the bus bars 15 and the sensing substrate 100 may be positioned between the bus bars 15 and the sensing substrate 100, and the connection units 50 may mediate transfer of state information of the battery cells 10 between the bus bars 15 and the sensing substrate 100. In an embodiment, the connection units 50 may not only transfer state information of the battery cells 10 but may also generate electrical signals related to the state information of the battery cells 10 and transfer the generated state information of the battery cells to the sensing substrate 100.

In an embodiment, the connection unit 50 includes a first connection region 51 thermally and/or electrically connected to the bus bar 15 and a second connection region 52 electrically connected to the sensing substrate 100 to mediate the transfer of state information of the battery cells 10 between the bus bar 15 and the sensing substrate 100. The connection unit 50 may include a sensing device 55 for generating state information of the battery cells 10 transferred through the first connection region 51 as electrical signals. The state information may include temperature or voltage of the battery cells 10. However, in an embodiment, the sensing device 55 may be formed at the second connection region 52 connected to the sensing substrate 100 from among the first connection region 51 connected to the bus bar 15 and the second connection region 52 connected to the sensing substrate 100.

In some embodiments, the first connection region 51 may transfer temperature information of the bus bar 15 to the sensing device 55 at the second connection region 52 while forming a thermal connection with the bus bar 15 and may transfer voltage information of the bus bar 15 to the sensing device 55 at the second connection region 52 while forming an electrical connection with the bus bar 15. In addition, the state information of the battery cells 10 generated from the sensing device through the second connection region 52 may be transferred to the main body 101 of the sensing substrate 100.

In an embodiment, the first connection region 51 may include a metal terminal. In one embodiment, the first connection region 51 may include a metal terminal including a nickel plate having excellent thermal and electrical conduction properties. The first connection region 51 may be connected to the bus bar 15 through a welding joint unit W. In an embodiment, the first connection region 51 may be connected to the bus bar 15 through laser welding.

In an embodiment, the second connection region 52 may be provided as a one-sided circuit board or a double-sided circuit board. In an embodiment in which the second connection region 52 is provided as a double-sided circuit board, one side of the second connection region 52 may be connected to the sensing device 55 and the other side thereof may be connected to the sensing substrate 100, and the second connection region 52 may be electrically connected to the sensing device 55 and the sensing substrate 100 through soldering. In an embodiment, the second connection region 52 as a location of the connection unit 50 mediating the connection with the sensing substrate 100 may refer to a region formed at the connection unit 50 and, as described below, may correspond to the connection position P1 and P2 formed at the sensing substrate 100. In an embodiment, the connection unit 50 and the sensing substrate 100 may connected to each other through a connection between the second connection region 52 of the connection unit 50 and the connection position P1 and P2 of the sensing substrate 100, and thus, the second connection region 52 of the connection unit 50 between the connection unit 50 and the sensing substrate 100 may be understood as the same as the connection position P1 and P2 of the sensing substrate 100. For example, the second connection region 52 may refer to one component of the connection unit 50, and the connection position P1 and P2 may refer to one component of the sensing substrate 100. As described below, in an embodiment, the connection unit 50 may include first and second connection units 501 and 502 connected to first and second bus bars 151 and 152 adjacent to each other in the first direction Z1, and similarly, the connection position P1 and P2 may include first and second connection positions P1 and P2 respectively connected to the first and second bus bars 151 and 152 adjacent to each other in the first direction Z1, where the first and second connection units 50 (e.g., the second connection regions 52 of the first and second connection units 501 and 502) adjacent to each other in the first direction Z1 and the first and second connection positions P1 and P2 may be formed at substantially the same position on a plane formed by the first and second directions Z1 and Z2 while being connected to each other at positions corresponding to each other.

Hereinafter, a configuration of the sensing substrate 100 for collecting state information of the battery cells 10 will be described in more detail. The sensing substrate 100 may include the main body 101 and the branch portions B connected thereto and bypassing the main body 101 to approach (e.g., to extend toward) the bus bars 15 with the first deformation accommodating spaces G1 between the main body 101 and the branch portions B. The branch portions B may extend in parallel in the first direction Z1 together with the main body 101 and may be offset from (e.g., spaced apart from) the main body 101 toward the bus bars 15 in the second direction Z2 crossing the first direction Z1 in which the plurality of battery cells 10 are arranged. The branch portions B may be elongated substantially in the first direction Z1, and first support units S1 connected to the main body 101 of the sensing substrate 100 may be formed at both ends (e.g., opposite ends) of the branch portion B extending in the first direction Z1. In an embodiment, the branch portion B may provide the connection positions P1 and P2 with the connection units 50 between the first support units S1 at both ends, and the ring unit R in the form of a closed loop surrounding the second deformation accommodating space G2 together with the connection positions P1 and P2 with the connection units 50 may be formed on the branch portions B such that the branch portions B providing the connection positions P1 and P2 with the connection units 50 flexibly follow the displacement of the bus bars 15 or the connection units 50 connected to the bus bars 15 during, for example, swelling of the battery cells 10.

In an embodiment, the connection positions P1 and P2 of the connection units 50 may refer to positions at where the connection units 50 connecting the battery cells 10 and the sensing substrate 100 are connected to the sensing substrate 100, and in an embodiment, the connection positions P1 and P2 of the connection units 50 may include the first and second connection positions P1 and P2 connected to the different first and second connection units 501 and 502 in the first direction Z1. For example, in an embodiment, the first and second connection positions P1 and P2 connected to the adjacent first and second bus bars 151 and 152 via the first and second connection units 501 and 502 may refer to positions at where the first and second connection units 501 and 502 adjacent to each other in the first direction Z1 are connected to the sensing substrate 100 and may also refer to positions at where the first and second bus bars 151 and 152 adjacent to each other in the first direction Z1 are connected to the sensing substrate 100 via the first and second connection units 501 and 502. In this sense, the first and second connection positions P1 and P2 may refer to positions at where the first and second connection units 501 and 502 adjacent to each other in the first direction Z1 are connected or where the first and second bus bars 151 and 152 adjacent to each other in the first direction Z1 are connected. As described below, the ring unit R surrounding (or forming) the second deformation accommodating space G2 may be positioned between the first and second connection positions P1 and P2 arranged adjacent each other in the first direction Z1 to allow relative deformation or displacement between the first and second connection positions P1 and P2.

The first deformation accommodating space G1 may be formed between the main body 101 of the sensing substrate 100 and the branch portions B in the second direction Z2 crossing the first direction Z1, and the second deformation accommodating space G2 may be formed between the adjacent first and second connection positions P1 and P2 on the branch portions B extending in the first direction Z1. In an embodiment, both the first and second deformation accommodating spaces G1 and G2 may be surrounded by (e.g., surrounded in a plan view or surrounded along their peripheries by) the sensing substrate 100 and may be formed by components of the sensing substrate 100 surrounding the first and second first and second deformation accommodating spaces G1 and G2. For example, the first deformation accommodating space G1 may be surrounded by (e.g., may be formed by) the branch portions B, and more specifically, by the branch portions B and the main body 101 of the sensing substrate 100. The second deformation accommodating space G2 may be surrounded by the ring unit R of the sensing substrate 100. In an embodiment, the first and second deformation accommodating spaces G1 and G2 may be formed to be closed from the outside (e.g., may be surrounded by the branch portions B and the main body 101 of the sensing substrate 100), and the second deformation accommodating space G2 may be formed to be closed from the outside surrounded by the ring unit R. For example, the branch portions B may at least partially surround the first deformation accommodating space G1, while the ring unit R may surround the second deformation accommodating space G2 completely or entirely.

In an embodiment, the first and second deformation accommodating spaces G1 and G2 adjacent to the connection positions P1 and P2 are formed through the shape of the branch portions B and the ring unit R connected to the connection positions P1 and P2 so that the relative displacement of the connection positions P1 and P2 connected to the bus bars 15 or the connection units 50 may be allowed to comply with (or follow) the displacement of the bus bars 15 due to the swelling of the battery cells 10 or the displacement of the connection units 50 connected to the bus bars 15. The first and second deformation accommodating spaces G1 and G2 accommodating the deformation of the branch portions B and the ring unit R may allow the branch portions B and the ring unit R to flexibly deform according to the displacement of the connecting positions P1 and P2. For example, the deformation of the branch portions B and the ring unit R, such as dents or creases in the branch portions B and the ring unit R, may be induced by accommodating the deformation through the first and second deformation accommodating spaces G1 and G2, and the flexible deformation or displacement of the connection positions P1 and P2 may be allowed by (or induced by) the first and second deformation accommodating spaces G1 and G2.

In an embodiment, because the first and second deformation accommodating spaces G1 and G2 are surrounded by the sensing substrate 100 and formed to be closed from the outside, the sensing substrate 100 may not be warped, fluttered, or lifted from the plane on which the sensing substrate 100 is arranged and co-planarity of the sensing substrate 100 may be maintained. On the other hand, when the first and second deformation accommodating spaces G1 and G2 are formed to be open to the outside, a part (e.g., the branch portions B forming the first deformation accommodating space G1 or the ring unit R forming the second deformation accommodating space, particularly, ends that open the first and second deformation accommodating spaces G1 and G2 from among the branch portions B and the ring unit R) of the sensing substrate 100 surrounding the first and second deformation accommodating spaces G1 and G2 may not maintain the co-planarity on the plane on which the sensing substrate 100 is arranged, and the connection positions P1 and P2 may be too flexible due to deformation such as twisting, fluttering, lifting, etc., thereby deteriorating connectivity with the connection units 50 at the connection positions P1 and P2.

In an embodiment, the first deformation accommodating space G1 may be elongated in the first direction Z1 in which the plurality of battery cells 10 are arranged and may be elongated in the first direction Z1 between the branch portions B extending substantially in parallel in the first direction Z1 and the main body 101 of the sensing substrate 100. For example, when the first deformation accommodating space G1 is distorted in the first direction Z1 in which the plurality of battery cells 10 are arranged, or in the first direction Z1 in which the swelling of the plurality of battery cells 10 is accumulated, the branch portions B forming the first deformation accommodating space G1 and the connection positions P1 and P2 connected to the branch portions B may be deformed or displaced in the first direction Z1. In an embodiment, the first deformation accommodating space G1 may be elongated in the first direction Z1 between the branch portions B and the main body 101 of the sensing substrate 100, and positions of both ends of the first deformation accommodating space G1 are closed by the first support units S1 connecting the branch portions B and the main body 101 of the sensing substrate 100.

In some embodiments, the first deformation accommodating space G1 may include one space formed between the branch portions B and the main body 101 of the sensing substrate 100 or a plurality of spaces formed by dividing the space into two or more spaces between the branch portions B and the main body 101 of the sensing substrate 100. As described below, in an embodiment, the first deformation accommodating space G1 may be divided into two spaces (e.g., two deformation accommodating spaces) by a second support unit S2 extending from the ring unit R, which is connected to the branch portions B, to the main body 101 of the sensing substrate 100.

In an embodiment, the second deformation accommodating space G2 may be formed in a closed loop shape surrounded by the ring unit R connected to the branch portions B and may be formed in a circular closed loop shape according to the shape of the ring unit R. In an embodiment, because the ring unit R is formed in the circular closed loop shape, the ring unit R may be flexibly deformed in response to thermal stress acting in various directions including first and second directions Z1 and Z2 according to thermal expansion of the battery cells 10 and may not have a specific orientation. However, in some embodiments, the ring unit R may be formed in various polygonal shapes including ovals and quadrangles in addition to the circular shape and may have anisotropy in that it reacts different depending on the direction of thermal stress applied thereto.

For example, when the second deformation accommodating space G2 is distorted in the first direction Z1 in which the plurality of battery cells 10 are arranged or in the first direction Z1 in which the swelling of the plurality of battery cells 10 is accumulated, the ring unit R forming the second deformation accommodating space G2 and the connection positions P1 and P2 connected to the ring unit R may be deformed or displaced in the first direction Z1. In an embodiment, the ring unit R or the second deformation accommodating space G2 formed by the ring unit R may be formed between the different first and second connection positions P1 and P2 in the first direction Z1 and may elastically connect the first and second connection positions P1 and P2 while allowing relative displacement between the first and second connection positions P1 and P2. The first and second bus bars 151 and 152 (e.g., the adjacent first and second connection units 501 and 502 connected to the first and second bus bars 151 and 152 adjacent to each other in the first direction Z1) adjacent to each other in the first direction Z1 may be connected to the first and second connection positions P1 and P2, respectively, and the ring unit R or the second deformation accommodating space G2 formed by the ring unit R may flexibly connect the first and second connection positions P1 and P2 to which the first and second bus bars 151 and 152 adjacent to each other in the first direction Z1 are connected. The first and second connection positions P1 and P2 may be formed at different locations of the branch portions B extending in the first direction Z1 and may include the first connection position P1 formed between the ring unit R and the first support unit S1 formed at one end of the branch portions B and the second connection position P2 formed between the ring unit R and the first support unit formed at the other end of the branch portions B.

In an embodiment, the ring unit R forming the second deformation accommodating space G2 may support other components of (or parts of) the sensing substrate 100 through the two or more second support units S2 formed around the ring unit R. For example, in an embodiment, the ring unit R may be connected to the branch portions B through the second support units S2 on both ends in the first direction Z1 and may be connected to the branch portions B in which the first and second connection positions P1 and P2 are respectively formed. In an embodiment, the ring unit R may be supported by the branch portions B of the sensing substrate 100 extending to both sides of the ring unit R in the first direction Z1 and extending to the main body 101 of the sensing substrate 100 through the three second support units S2 formed around the ring unit R. For example, the ring unit R may be connected to both sides of the branch portions B through the second support units S1 and may be connected to the main body 101 of the sensing substrate 100 through the other second support unit S2. In addition, the second support unit S1 connecting the ring unit R and the main body 101 of the sensing substrate 100 may divide the first deformation accommodating space G1 formed between the branch portions B in which the ring unit is formed and the main body 101 of the sensing substrate 100 into two first deformation accommodating spaces G1 spaces, and the two first deformation accommodating spaces G1 may be formed by dividing the first deformation accommodating space G1 by the second support unit S2 between the branch portions B and the main body 101 of the sensing substrate 100.

In an embodiment, the sensing substrate 100 may include the main body 101 of the sensing substrate 100 and the branch portions B spaced from the main body 101 of the sensing substrate 100 to an outer position from (e.g., spaced apart from) the main body 101 of the sensing substrate 100 to provide (e.g., to form) the first deformation accommodating space G1. Throughout the description, the branch portions B may refer to a portion spaced apart from the main body 101 to provide the first deformation accommodating space G1 therebetween in whole or in part. In this sense, it may be understood that the first support units S1 connect the branch portions B, which form the first deformation accommodating space G1, to the main body 101 of the sensing substrate 100, and it may also be understood that the branch portions B may include the first support units S1. As such, throughout the description, the branch portions B may refer to a portion spaced apart from the main body 101 of the sensing substrate 100 to provide therebetween the first deformation accommodating space G1 in whole or in part. In this sense, it may be understood that the second support units S2 may connect the ring unit R to the branch portions B and it may also be understood that the branch portions B include the second support units S2. In an embodiment, the branch portions B including first support units S1 formed at both ends of the first deformation accommodating space G1 in the first direction Z1 and a pair of the second support units S2 formed at both ends of the ring unit R surrounding the second deformation accommodating space G2 in the first direction Z1 may collectively refer to a portion which is spaced apart from the main body 101 of the sensing substrate 100 by providing (e.g., by forming) the first deformation accommodating space G1 from the main body 101 of the sensing substrate 100 in whole.

In an embodiment, the first and second deformation accommodating spaces G1 and G2 may be formed to be closed from the outside (e.g., may be completely surrounded in a plan view by a part of the sensing substrate 100), thereby fixing the connection positions P1 and P2 with the connection units 50 so that they do not move arbitrarily. For example, the connection between the bus bars 15 and the sensing substrate 100 by using the connecting units 50 may be easily made while maintaining the co-planarity of the sensing substrate 100 in whole.

In an embodiment, in the battery pack to which the connection of the bus bars 15 is completed, the first and second deformation accommodating spaces G1 and G2 may allow flexible deformation or displacement to conform to the swelling of the battery cells 10 by deformation or displacement of the connection positions P1 and P2 connected to the bus bars 15 or the connection units 50 and may relieve the internal stress accumulated in the sensing substrate 100, thereby preventing damage to the sensing substrate 100 due to accumulated internal stress. However, in the battery pack before the connection with the bus bars 15 is completed, the sensing substrate 100 may be temporarily fixed through the first and second deformation accommodating spaces G1 and G2 considering the connectivity with the bus bars 15 and for the purpose of improving distribution or handling of the sensing substrate 100. Throughout the description, temporarily fixing the sensing substrate 100 may refer to, for example, fixing at least a part of the sensing substrate 100, such as the branch portions B and the ring unit R, by using pin members F1 and F2 fitted into the branch portions B and the ring unit R, as a part of the sensing substrate 100, rather than completely fixing the sensing substrate 100 in position.

Hereinafter, a structure for temporarily fixing the sensing substrate 100 through the first and second deformation accommodating spaces G1 and G2 will be described in more detail. For example, by temporarily fixing the sensing substrate 100 at the first and second deformation accommodating spaces G1 and G2, the connectivity of the bus bars 15 may be improved. For example, the first and second deformation accommodating spaces G1 and G2 may by temporarily fixed to prevent movement of the connection positions P1 and P2 with the connection units 50 and to enable stable connection with the bus bars 15. For example, the pin members F1 and F2 for temporarily fixing the branch portions B and the ring unit R may be fitted into at least a part of the first and second deformation accommodating spaces G1 and G2 (see, e.g., FIG. 4). For example, in an embodiment, the pin members F1 and F2 may be fitted into both ends of the first deformation accommodating space G1 and the second deformation accommodating space G2 as a part of the first and second deformation accommodating spaces G1 and G2.

In an embodiment, for connection with the bus bars 15 and/or convenience in distribution and handling of the sensing substrate 100, the pin members F1 and F2 may be fitted into at least a part of the first and second deformation accommodating spaces G1 and G2. For example, the first pin members F1 may be fitted into both ends of the first deformation accommodating space G1 and, in one embodiment, may be fitted into the first support units S1, respectively, formed at both ends of the first deformation accommodating space G1. Considering the connection with the first pin members F1 (e.g., considering the contact area with the first pin members F1 having a circular cross section), the first support units 51 may be formed in a rounded shape. In other words, the first support units 51 may have a rounded shape to connect the branch portions B with the main body 101 extending in parallel in the first direction Z1. The second pin member F2 may be fitted into the second deformation accommodating space G2, and considering the contact area with the second pin member F2 having a circular cross section, the second deformation accommodating space G2 may be formed in a circular closed loop shape.

In an embodiment, even though the first and second pin members F1 and F2 are fitted into the first and second deformation accommodating spaces G1 and G2, the first and second pin members F1 and F2 stably maintain the connection positions P1 and P2 connected to the branch portions B and the ring unit R by temporarily fixing the branch portions B and the ring unit R, thereby improving distribution and handling convenience of the sensing substrate 100 and/or the connectivity with the bus bars 15. In the battery pack to which the connection of the bus bars 15 is completed, the first and second pin members F1 and F2 may be removed from the first and second deformation accommodating spaces G1 and G2 so that the first and second deformation accommodating spaces G1 and G2 can accommodate deformation of the branch portions B and the ring unit R surrounding the first and second deformation accommodating spaces G1 and G2. In a state in which restraints in the form of, for example, the first and second pin members F1 and F2 are excluded, the first and second deformation accommodating spaces G1 and G2 may sufficiently accommodate the deformation of the branch portions B and the ring unit R surrounding the first and second deformation accommodating spaces G1 and G2, and the connection positions P1 and P2 connected to the branch portions B and the ring unit R may be elastically deformed or displaced according to the swelling of the battery cells 10.

In an embodiment, a sensing structure that mediates the transfer of state information between the battery cells 10 and the sensing substrate 100 may be formed in a symmetrical shape (e.g., a symmetrical shape with the ring unit R or the second deformation accommodating space G2 formed by the ring unit R as the centers). In some embodiments, the first and second deformation accommodating spaces G1 and G2, and the branch and ring units B and R surrounding the first and second deformation accommodating spaces G1, G2 that form the sensing structure, may be formed in a symmetrical shape. For example, the first and second connection positions P1 and P2 may be formed on both sides of the ring unit R in the first direction Z1 with the ring unit R as the center, and the first support unit S1 at one end and the first support unit 51 at the other end connecting the branch portions B and the main body 101 of the sensing substrate 100 may be formed on the opposite sides of the ring unit R with the first connection position P1 and the second connection position P2 as the centers, respectively. As such, in an embodiment, because the sensing structure for mediating the transfer of state information between the battery cells 10 and the sensing substrate 100 is formed in a symmetrical shape, the connecting positions P1 and P2 or the sensing substrate 100 may be stably and temporarily fixed by fitting the first and second pin members F1 and F2 to the first and second deformation accommodating spaces G1 and G2 to temporarily fix the connection positions P1 and P2 and/or to temporarily fix the sensing substrate 100. For example, the connection positions P1 and P2 or the sensing substrate 100 may be stably and temporarily fixed at symmetrical positions with respect to each other.

In an embodiment, the symmetrical shape of the sensing structure mediating the transfer of state information between the battery cells 10 and the sensing substrate 100 will be described in more detail below. For example, around the ring unit R, the first and second connection positions P1 and P2 may be formed at an inner position adjacent to the ring unit R, and the first support unit S1 at one end and the first support unit 51 at the other end of the ring unit R may be formed at an outer position relatively far from the ring unit R. The first and second connecting positions P1 and P2 formed at an inner position around the ring unit R in the first direction Z1 may be formed in positions and shapes symmetrical to each other, and the first support unit S1 at one end and the first support unit S1 at the other end formed at an outer position in the first direction Z1 around the ring unit R may be formed in positions and shapes symmetrical to each other.

Throughout the description, the connection positions P1 and P2 may refer to positions at where the bus bars 15 or the connection units 50 connected to the bus bars 15 are connected to the sensing substrate 100. For example, the connection positions P1 and P2 may have appropriate areas and structures on which the second connection regions 52 of the connection units 50 are mounted to form an electrical connection with the second connection regions 52 of the connection units 50 (e.g., for the connection units 50 provided with a double-sided circuit board or a single-sided circuit board). The connection positions P1 and P2 may provide a stable support base for the second connection regions 52 of the connection units 50 because the connection positions P1 and P2 have a wider width (in the second direction Z2) than the branch portions B, and the connection positions P1 and P2 may include conductive patterns that may be electrically connected to the second connection regions 52 of the connection units 50.

According to embodiments of the present disclosure, a battery pack includes a sensing substrate having deformation accommodating spaces so that a part of the sensing substrate for acquiring state information of battery cells may be flexibly deformed due to, for example, positional movement of bus bars due to volume expansion (e.g., swelling) of the battery cells caused during charging and discharging of the battery cells. Thus, the sensing substrate may flexibly follow to movement of the bus bars to reduce or prevent the accumulation of internal stress and the resulting damage.

It should be understood that the embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims and their equivalents.

What is claimed is:

1. A battery pack comprising:
a plurality of battery cells; and
a sensing substrate configured to collect state information from the plurality of battery cells, the sensing substrate comprising:
a main body;
branch portions connected to the main body and spaced apart from the sensing substrate such that first deformation accommodating spaces are formed between the main body and the branch portions; and
ring units connected to the branch portions and forming second deformation accommodating spaces.

2. The battery pack of claim 1, wherein the branch portions and the main body surround the first deformation accommodating spaces in a plan view, and
wherein the ring units entirely surround the second deformation accommodating spaces in the plan view.

3. The battery pack of claim 1, wherein the first and second deformation accommodating spaces are closed spaces.

4. The battery pack of claim 1, wherein the first deformation accommodating spaces extend in a first direction between the branch portions, and
wherein the main body of the sensing substrate extends in the first direction.

5. The battery pack of claim 4, wherein the first deformation accommodating space is closed by first support units connected to the main body at both ends in the first direction.

6. The battery pack of claim 5, wherein the first support units have a rounded shape at where they connect the branch portions and the main body to each other.

7. The battery pack of claim 1, wherein each of the ring units has a circular closed loop shape and surrounds each of the second deformation accommodating spaces in a plan view.

8. The battery pack of claim 1, wherein the ring units are connected to the main body and the branch portions extending to both sides of each of the ring units by three second support units extending from a periphery of the ring unit.

9. The battery pack of claim 8, wherein one second support unit from among the second support units connecting the ring unit and the main body divides the first deformation accommodating space formed between the branch portions and the main body of the sensing substrate into two deformation accommodating spaces.

10. The battery pack of claim 1, wherein connection positions connected to the battery cells are formed on the branch portions.

11. The battery pack of claim 10, wherein the connection positions comprise first and second connection positions at both sides of each of the ring units with the ring units as the center.

12. The battery pack of claim 11, wherein the first and second connection positions are arranged in a first direction in which the plurality of battery cells are arranged.

13. The battery pack of claim 11, wherein the first and second connection positions are connected to first and second bus bars adjacent to each other in a first direction.

14. The battery pack of claim 13, wherein each of the first and second bus bars connects different battery cells to each other.

15. The battery pack of claim 14, wherein a first support unit at one end closing the first deformation accommodating space is formed on the opposite side of the ring unit with the first connection position as the center, and
wherein another first support unit at another end closing the first deformation accommodating space is formed on the opposite side of the ring unit with the second connection position as the center.

16. The battery pack of claim 15, wherein, with the center ring as the center, the first and second connection positions are formed adjacent to the ring unit, and
wherein the first support unit at one end and the first support unit at another end are formed relatively distant from the ring unit.

17. The battery pack of claim 13, wherein the first and second connection positions are connected to first and second connection units located adjacent to each other in the first direction for connection with the first and second bus bars.

18. The battery pack of claim 17, wherein the first and second connection positions are connected to the first and second connection units connected to the first and second bus bars.

19. The battery pack of claim 11, wherein the ring units are connected to the main body and the branch portions extending to both sides of each of the ring units by three second support units extending from a periphery of the ring unit, and
wherein the ring unit is connected, by the second support units formed on both sides of the ring unit, to the branch portion where the first connection position is formed and to the branch portion where the second connection position is formed.
